(19) United States
(12) Patent Application Publication
(10) Pub. No.: US 2015/0058743 A1
(43) Pub. Date: Feb. 26, 2015

(54) Method And System For Displaying Event Information

(71) Applicant: Kristopher R. Wall, Choctaw, OK (US)

(72) Inventor: Kristopher R. Wall, Choctaw, OK (US)

(21) Appl. No.: 14/464,338

(22) Filed: Aug. 20, 2014

Related U.S. Application Data
(60) Provisional application No. 61/869,836, filed on Aug. 26, 2013.

(51) Int. Cl. G06F 3/0484

(52) U.S. Cl. CPC G06F 3/04842; G06F 3/04847
USPC 715/744

(57) ABSTRACT

A method for displaying event information on web-based media. The method comprises providing a venue management user interface, a public user interface, and a dynamic public content interface. The interfaces are powered by data engines. A venue may register a plurality of different events within the venue management user interface. The plurality of different events are indexed and categorized by the data engines and displayed within the dynamic public content interface. A public user may set preferences within the public user interface of the location and type of events the public user would like to view. The public user may view the set preferences within the dynamic public content interface. The dynamic public content interface may display the events on a calendar or in a searchable form. The dynamic public content interface is always changing based on the venues and events registered within the venue management user interface.

### CROSS REFERENCE TO RELATED APPLICATION

This application claims the benefit of provisional patent application Ser. No. 61/869,836 filed on Aug. 26, 2013, the entire contents of which are incorporated herein by reference.

### FIELD

The present invention relates generally to electronic methods and systems for displaying event information, and relates specifically to socially created dynamic electronic calendars.

### SUMMARY

The present invention is directed to a method for managing events on web-based media. The method comprises providing a venue management user interface created by a processor and programmed to allow a plurality of different venues to register a plurality of different events, providing a data engine operated by a processor and programmed to process and manage the plurality of different events registered by the plurality of different venues, providing a public user interface created by the processor and programmed to allow a user to input a location and specify the type of venue or a type of event the user wants to view, providing a dynamic public content interface created by a processor and programmed to receive and display the specified type of venue or the type of event input by the public user, and providing one or more servers to host the venue management user interface, the date engine, the public user interface, and the dynamic public content interface. The method further comprises receiving at the venue management user interface a request from a venue user device to register an event, categorizing the event using the data engine, receiving at the public user interface a request from a public user device to view the event, and sending a command from the dynamic public content interface to the public user device to display the event.

The present invention is also directed to a method, by one or more processors associated with one or more computing devices. The method comprises the steps of registering, by one or more of the processors, a venue on a venue management interface, registering, by one or more of the processors, an event, created by the venue on the venue management interface, and generating, by one or more of the processors, a dynamic social calendar in a dynamic public content interface that displays the plurality of different events registered by the plurality of different venues. The method further comprises the steps of receiving, by one or more processors, a location and a type of event identified by a public user on a public user interface, and displaying, by one or more of the processors, on the dynamic social calendar in the dynamic public content interface the plurality of different venues and the plurality of different events that correspond to the location and the type of event identified by the public user on the public user interface.

The present invention is further directed to a method, by one or more processors associated with one or more computing devices. The method comprises the steps of registering, by one or more of the processors, a venue on a venue management interface, registering, by one or more of the processors, an event, created by the venue on the venue management interface, and categorizing, by one or more of the processors, a plurality of different events registered by a plurality of different venues based on a location of the plurality of different events and a type of event. The method further comprises the steps of generating, by one or more of the processors, a dynamic social calendar in a dynamic public content interface that displays the plurality of different events registered by the plurality of different venues, receiving, by one or more processors, a location and a type of event identified by a public user on a public user interface, and displaying, by one or more of the processors, on the dynamic social calendar in the dynamic public content interface the plurality of different venues and the plurality of different events that correspond to the location and the type of event identified by the public user on the public user interface.

### BRIEF DESCRIPTION OF THE DRAWINGS

FIG. 1 is a block diagram of the present invention.

FIG. 2 is a block diagram of a registration interface.

FIG. 3 is a block diagram of a venue management user interface.

FIG. 4 is a block diagram of a public user interface.

FIG. 5 is a block diagram of a dynamic public content interface.

FIG. 6 is a block diagram of a plurality of data engines for use with the present invention.

FIG. 7 is a detailed block diagram of the present invention.

### DESCRIPTION

When determining what events are taking place in a certain location, it may be necessary to consult a multitude of different media outlets, including newspapers, websites, and social media. It would be beneficial to consult only one media outlet in order to determine all of the types of events taking place on specific days at specific locations. In addition, it would be beneficial for venues to be able to control the information supplied on the media outlet concerning its advertised event. The present invention is directed to a dynamic social calendar system for use on interactive media, such as websites or electronic applications. The dynamic social calendar system provides a forum for venues to advertise any type of event and for public users to search all types of events in one place.

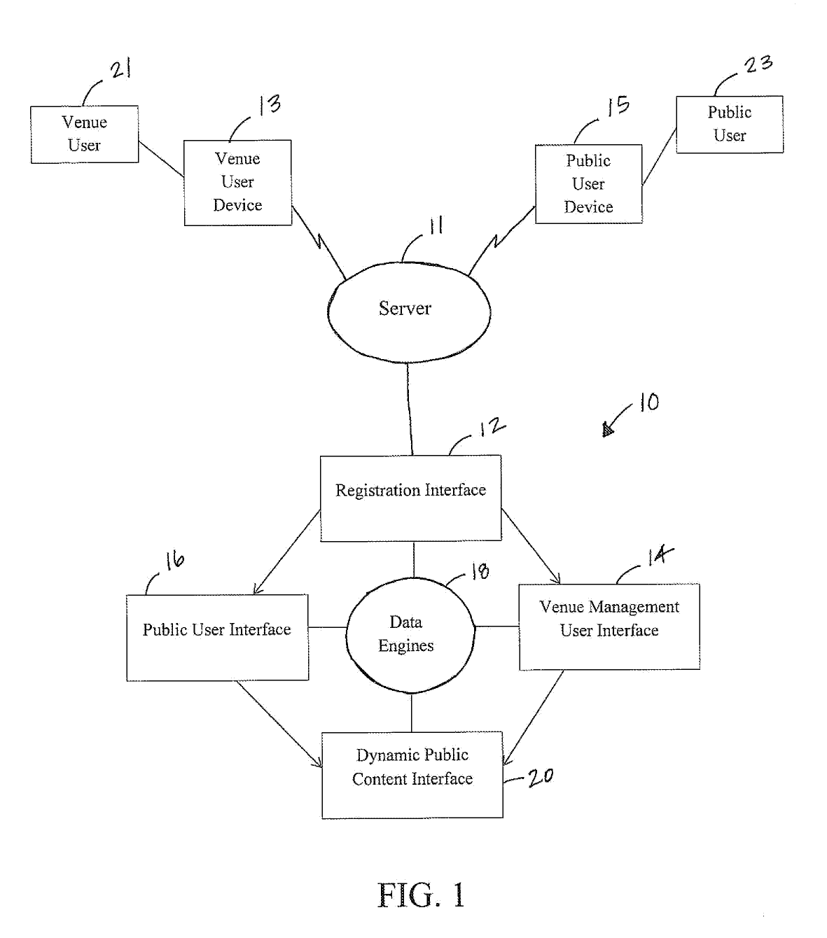

Turning to the figures, and first to FIG. 1, a diagram depicting the overall dynamic social calendar method and system 10 of the present invention is shown. The system 10 comprises a registration interface 12, a venue management user interface 14, a public user interface 16, a plurality of data engines 18, and a dynamic public content interface 20. The different interfaces may be created by one or more processors and stored on one or more servers 11. The one or more servers 11 may manage the different interfaces and communicate between a venue user device 13 and a public user device 15. The plurality of data engines 18 organize and manage the information on the system 10. The dynamic public content interface 20 displays the information for viewing on the system 10. The venue management user interface 14 interprets and organizes information provided from a plurality of different venue users 21, and the public user interface 16 interprets and organizes information provided from a public user 23. The venue user 21 and the public user 23 may register accounts with the system 10 on the registration interface 12.

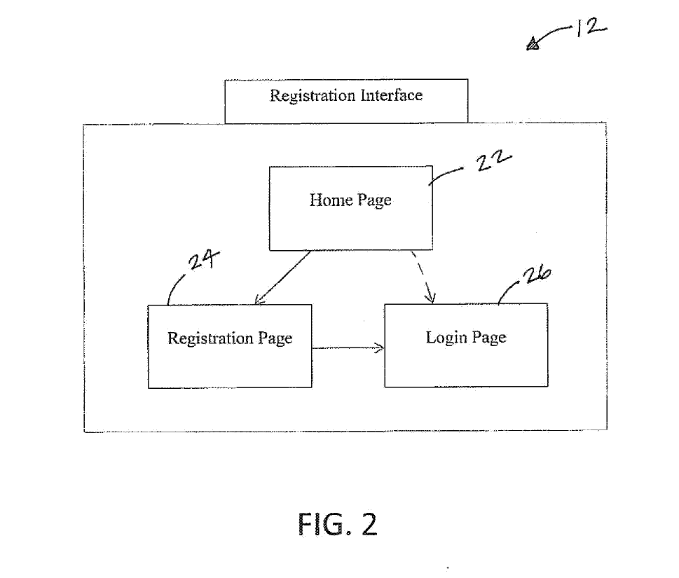

To start, the plurality of different venue users 21 may register their venue on the registration interface 12. When the venue user 21 accesses the system 10 on the venue user device 13, the device will generate a plurality of system pages (FIGS. 2-5) for display on the device by the venue user. When the venue user 21 registers its venue on the system 10 using the device 13, the device will send a request or signal to the registration interface 12 hosted and managed by the one or more servers 11 to register the venue. The data engines 18 hosted and managed by the one or more servers 11 will categorize the venue based on identified factors. The plurality of different venues may comprise restaurants, bars, concert venues, shops, museums, galleries, theaters, festivals, organizations, etc.

Once the venue user 21 registers its venue on the registration interface 12, the venue user can register a plurality of different events hosted by the venue on the venue management user interface 14. When the venue user 21 wants to register an event on the system 10 using the device 13, the device will send a request or signal to the venue management user interface 14 hosted and managed by the one or more servers 11 to register the event. The data engines 18 will then categorize the event based on identified factors. The plurality of different events may comprise concerts, benefits, plays, shows, etc. The events may be organized by the data engines 18 by the type of event, a location of the event, a date of the event, etc. After the data engines 18 organize the different types of venues and events, the data engines 18 may make this information accessible to the dynamic public content interface 20.

Continuing with FIG. 1, the public user 23 may access the system 10 by using the public user device 15. The public user 23 may register a public user account in the registration interface 12 by using the public user device 15 to send signals to the registration interface hosted and managed by the one or more servers 11. After registering, the public user 23 may be able to access the public user interface 16 and the dynamic public content interface 20. The public user interface 16 allows the public user 23 to identify events the public user would like to view. The public user 23 may view the events by accessing the dynamic public content interface 20 using the public user device 15. The dynamic public content interface 20 will communicate with the data engines 18 to identify the information the public user 23 would like to view. The dynamic public content interface 20 will then send a signal or command to the public user device 15 to generate and display the requested event or events for viewing on the public user device.

The event or events displayed to the public user 23 on the public user device 15 may be updated by the data engines 18 in real-time based on new events registered or changes to already registered events by venue users 21. The one or more servers 11 which manage the system 10 may be managed by a third party system manager. The system manager may add, remove, or revise categories for the data engines 18 to sort the types of venues and events as needed. The system manager may also add, remove, or revise preferences for the public user to choose as needed.

Turning now to FIG. 2, the registration interface 12 is shown in more detail. The registration interface 12 comprises a home page 22, a registration page 24, and a login page 26. The pages are generated by the venue user device 13 or the public user device 15 via signals from the registration interface 12 managed by the one or more servers 11. The registration page 24 and the login page 26 are accessible from the home page 22. The venue user 21 may register its venue on the registration page 24. Additionally, the public user 23 may register a public user account on the registration page 24. After the venue user 21 or public user 23 registers an account, they can access pages managed by the venue management user interface 14 or the public user interface 16 via the login page 26. The public user 23 may also skip registration and continue anonymously into pages managed by the public user interface 16.

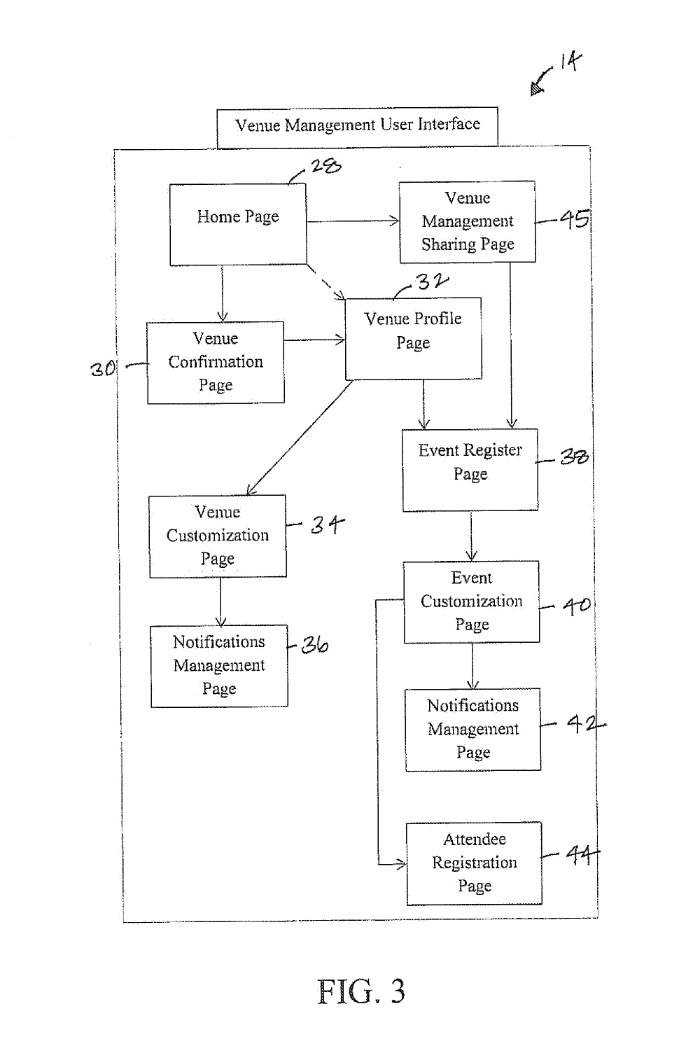

Turning now to FIG. 3, the venue management user interface 14 is shown in more detail. The venue management user interface 14 allows the venue user 13 to create and manage its account, billing options, profile, and events. The venue management user interface 14 manages in part a home page 28, a venue confirmation page 30, a venue profile page 32, a venue customization page 34, and a notifications management page 36. Once the venue user 21 accesses pages controlled by the venue management user interface 14, the venue user may first confirm the authenticity of the registered venue on the venue confirmation page 30. Once confirmed, the venue user 21 may continue to the venue profile page 32. The venue user 21 may create a profile for the venue on the profile page 32. The profile may include the location of the venue, the type of venue, and any other identifying information concerning the venue. The data engines 18 may use this information to categorize and index the venue information for display on pages managed by the dynamic public content interface 20. The venue user 21 may also control its billing options or advertising options within the venue's profile page 32.

The venue user 21 may also make a customized venue page on the venue customization page 34. This page may be accessible by the public user 23 on pages controlled by the dynamic public content interface 20. The venue user 21 may include any information desired on the venue's customization page 34, including general information about the venue, upcoming events, and promotions. Each venue's customization page 34 may also comprise areas for the public user 23 to comment about the venue. The venue user 21 will be notified about any comments via the notifications management page 36. The venue user 21 may answer questions or communicate with the public user 23 about the venue on the venue's customization page 34.

Continuing with FIG. 3, the venue management user interface 14 may also manage an event register page 38, a customization event page 40, a notifications management page 42, and an attendee registration page 44. Once the venue user 21 has created the venue's profile, the venue user may start to register events on the event register page 38. The venue user 21 may register the location, date, time, type of event, and any other needed information. The data engines 18 will categorize and index the registered event for access by the dynamic public content interface 20.

The venue user 21 may also create a customized page on the customization event page 40 for each event. The customized page may include more details regarding the event and may be viewable on pages managed by the dynamic public content interface 20. The customized page for each event may also include areas for the public user 23 to comment on the events. The venue user 21 will receive notifications of the comments on the notifications management page 42. The venue user 21 may answer questions or communicate with the public user 23 about the event on the customized event page 40. The customized page for each event may also include a link for the public user 23 to RSVP to the event or the page may include areas for the public user to register for the events if needed. The venue user 21 may manage the guest list and any registrations from the public user 23 on the attendee registration page 44.

The venue management user interface 14 may also manage a venue management sharing page 45. The venue management sharing page 45 allows the venue user 21 to give limited access to the venue's event register page 38 to a second venue user. This may be necessary if a second venue is hosting an event at the first venue's location or at a venue the second venue does not own or normally operate. The second venue could access the first venue's register page 38 in order to register an event at the first venue's location. This may be necessary, for example, if a bar is hosting a large party at a conference center. The bar would be able to register the event under the conference center's venue page.

The venue management user interface 14 is powered by the individual venue users 21. The venue users 21 may update, change, remove, or revise information as desired on their profile pages 32, customized venue pages 34, or customized event pages 40. This information is then sent to the venue management user interface 14 on the one or more servers 11 and uploaded and organized by the data engines 18 for access in real-time by the dynamic public content interface 20. The venue users 21 may also add, remove, or revise registered events as desired on the event register pages 38. The different pages and the navigation of the different pages controlled by the venue management user interface 14 may be changed as desired by the system manager.

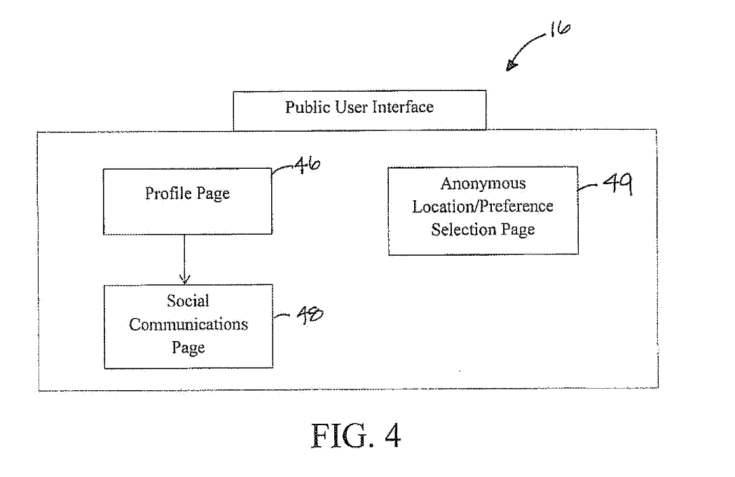

Turning now to FIG. 4, the public user interface 16 is shown in more detail. If the public user 23 creates a public user account managed by the registration interface 12, the public user can login from the login page 26 to access other pages managed by the public user interface 16. Once logged in, the public user 23 can set up a profile on the public user profile page 46. The public user 23 may set preferences regarding the location the public user would like to view events at, the type of event, and/or the type of venue the public user would like to view. Additional types of preferences may be included for management by the public user interface 16 as needed. The data engines 18 will use the set preferences to automatically filter out information the public user 23 may view on pages managed by the dynamic public content interface 20 each time the public user logs in. These preferences may be changed as desired. The registered public user 23 may also access a social communications page 48 from the public users profile page 46 to discuss the different events or venues. The social communications page 48 may be managed by the public user interface 16.

Continuing with FIG. 4, pages managed by the public user interface 16 may also be accessed anonymously without requiring the public user 23 to create an account or login from pages managed by the registration interface 12. If the public user 23 accesses pages managed by the public user interface 16 anonymously, the public user may be directed to the anonymous location/preference selection page 49. The public user 23 may choose a location to view, a type of event, and/or a type of venue to view on pages managed by dynamic public content interface 20 on the anonymous location/preference selection page 49. Additional options to filter out information for display on pages managed by the dynamic public content interface 20 may be added as needed. After the public user 23 has either logged in or anonymously selected preferences to view, the public user may then choose to view the pages and information managed by the dynamic public content interface 20. Alternatively, the public user may continue to pages managed by the dynamic public content interface 20 without choosing to filter out any information.

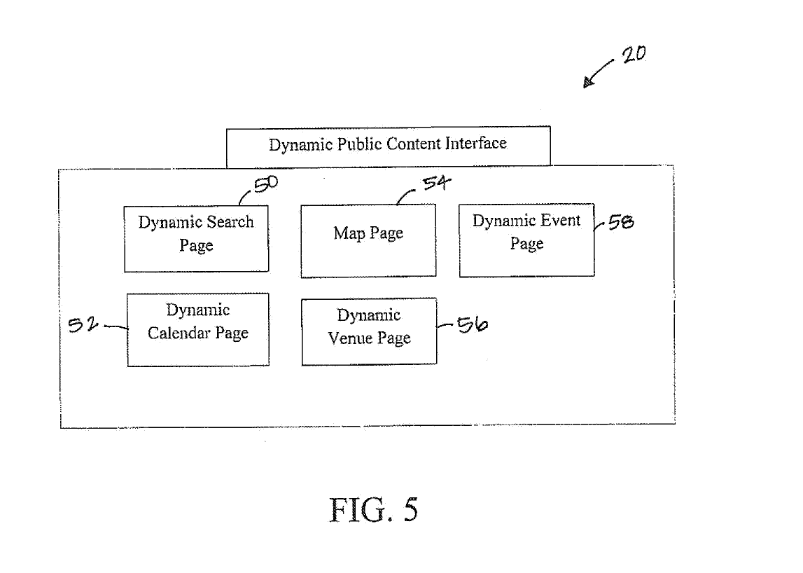

Turning now to FIG. 5, the dynamic public content interface 20 is shown in more detail. The dynamic public content interface 20 manages a dynamic search page 50, a dynamic calendar page 52, a map page 54, a dynamic venue page 56, and a dynamic event page 58. The dynamic search page 50 allows the public user 23 to do a general key word search through all venues and events. This search may be limited to the location, the type of venue, and/or the type of event previously selected by the public user 23 on pages managed by the public user interface 16, or the search may be over a broad range of different locations and topics.

Continuing with FIG. 5, the dynamic calendar page 52 displays all events registered for specific days on a dynamic calendar. The calendar may be viewed in days, weeks, months, or years. The information displayed on the calendar may be filtered based on the preferences selected by the public user. For example, the calendar may show all events for a specific month taking place in a specific city. Alternatively, the calendar may show only one or multiple different types of events taking place in a specific month within a specific city, or the calendar may be limited to show all of the events registered by one specific venue for a specific month within a specific city. The information displayed on the calendar may be as specific or as broad as desired by the public user 23. The information displayed may also be color coded based on the category of venues or events.

The map page 54, shown in FIG. 5, displays all of the registered venues or events on a map of a specific location. The map may be changed to different cities and may be viewed at varying magnifications. The information displayed on the map may be filtered as desired by the public user 23. The dynamic venue page 56 shows all of the registered venues. The venues may be filtered to only display venues in a certain area or to only display certain types of venues. Similarly, the dynamic event page 58 displays all of the registered events. The events may be filtered to only display events in a certain area, events at specific venues, or to only display certain types of events.

The venues and events displayed on pages managed by the dynamic public content interface 20 are powered by the community. The venues and events may change in real-time as the venue users 21 add or delete venues and events. The different venues and events organized by the data engines 18 and displayed on pages managed by the dynamic public content interface 20 are linked to the customized venue and event pages 34 and 40 created by the venue. If the public user 23 finds a venue or an event he wants more information about he can click on the venue or event and be directed to the customized pages 34 and 40 managed by the venue management user interface 14 that provide more information.

Referring now to FIGS. 3-5, the venue user 21 may choose to advertise its venue or advertise certain events on pages managed by the public user interface 16 or the dynamic public content interface 20. The venue user 21 may choose these options within the venue's profile page 32. The advertisement may be displayed for the public user 23 on the different pages while the public user is navigating the pages managed by the different interfaces. Alternatively, the advertisement may be displayed on pages managed by the registration interface 12 and the venue management user interface 14.

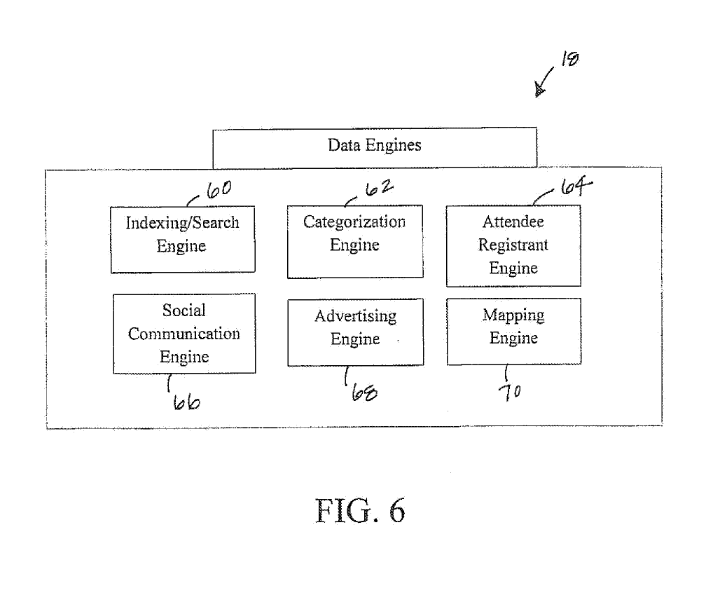

Turning now to FIG. 6, the plurality of data engines 18 are shown. The plurality of data engines 18 comprise an indexing/search engine 60, a categorization engine 62, an attendee registrant engine 64, a social communication engine 66, an advertising engine 68, and a mapping engine 70. The indexing/search engine 60 indexes the plurality of different venues and the plurality of different events based on the location of the venue and event, the type of venue, the type of event, and the date of the event. The indexing/search engine 60 uses information from the venue profile page 32 and the event register page 38 provided in the venue management user interface 14 to index the different venues and events. The indexing/search engine 60 also searches through all of the venues and events based on different searches identified by the public user 23 in the public user interface 16 or the dynamic public content interface 20.

Continuing with FIG. 6, the categorization engine 62 categorizes the different venues and events based on the type of venue or type of event. The categorization engine 62 uses the information provided in the venue profile page 32 and the event register page 38 to place the venues and events into different categories. The different categories may be displayed on pages managed by the public user interface 16 for the public user 23 to set preferences from and the dynamic public content interface 20 for the public user to browse and search through. The attendee registrant engine 64 organizes RSVPs and/or registrations from public users 23 to different events and notifies the venue users 21 of the people attending or registering for that venue's events. The social communication engine 66 powers the social communications page 48 that may be used by registered public users 23 and powers and organizes comments that may be written of the different customized venue or event pages. The advertising engine 68 controls the placement and extent of advertising within the different interfaces as directed by the venue users 21. The venue users 21 may purchase within the venue management interface 14 any extent of advertising throughout the different interfaces they desire. The mapping engine 70 powers the map page 54. The mapping engine 70 organizes the venues and events on a map based on the location of the venue and event. The mapping engine 70 may also filter the events and venues shown on pages managed by the dynamic public content interface 20 based on the location on the map and the type of venue or event desired to be displayed.

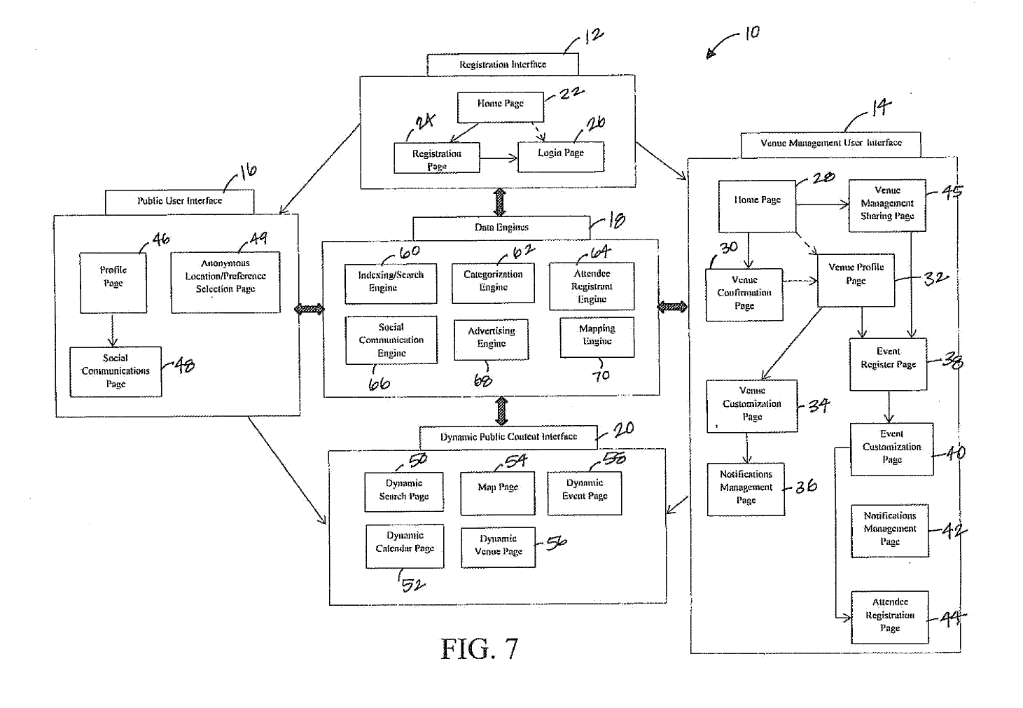

Turning now to FIG. 7, the system 10 is shown in more detail. In operation, the venue user 21 will start at the registration interface 12. The venue user 21 will register an account on the registration page 24 and then login on the login page 26. The venue user 21 will then be directed to pages managed by the venue management user interface 14. Once at these pages, the venue user 21 will first confirm the authenticity of the venue on the venue confirmation page 30. Once confirmed, the venue user 21 may create a profile on the profile page 32. The venue user 21 may manage billing options and advertising options within the venue profile page 32. The venue user 21 may register different events on the event register page 38. Information from the venue profile page 32 and the event register page 38 will be organized by the data engines 18 and displayed on pages managed by the dynamic public content interface 20.

Continuing with FIG. 7, the public user 23 may register an account on the registration interface 12 or the public user may continue anonymously into pages managed by the public user interface 16. If the public user 23 registers an account, the public user 23 may login to access these pages. Once at pages managed by the public user interface 16, the public user 23 may create a profile and choose different preferences to view on pages managed by the dynamic public content interface 20. The data engines 18 will filter out the preferences set by the public user 23 and display the public user's preferences within the dynamic public content interface 20. The public user may also change the set preferences or search through different locations, venues, and events on pages managed by the dynamic public content interface 20. The plurality of different events may be displayed and viewed on a calendar that is constantly updated in real-time by the different venue users 21. The individual interfaces may be changed and varied as needed to improve the quality of the system 10.

Various modifications can be made in the design and operation of the present invention without departing from its spirit. Thus, while the principle preferred construction and modes of operation of the invention have been explained in what is now considered to represent its best embodiments, it should be understood that within the scope of the appended claims, the invention may be practiced otherwise than as specifically illustrated and described,

What is claimed is:

1. A method for managing events on web-based media, comprising:
providing a venue management user interface created by a processor and programmed to allow a plurality of different venues to register a plurality of different events;
providing a data engine operated by a processor and programmed to process and manage the plurality of different events registered by the plurality of different venues;
providing a public user interface created by a processor and programmed to allow a user to input a location and specify a type of venue or a type of event the user wants to view;
providing a dynamic public content interface created by a processor and programmed to receive and display the specified type of venue or the type of event input by the public user;
providing one or more servers to host the venue management user interface, the data engine, the public user interface, and the dynamic public content interface;
receiving at the venue management user interface a request from a venue user device to register an event;
categorizing the event using the data engine;
receiving at the public user interface a request from a public user device to view the event; and
sending a command from the dynamic public content interface to the public user device to display the event.

2. The method of claim 1 further comprising uploading the event to be viewed on pages managed by the dynamic public content interface in real-time.

3. The method of claim 1 further comprising providing more than one data engine operated by a processor and programmed to process and manage the plurality of different events registered by the plurality of different venues.

4. The method of claim 1 further comprising programming the data engine to build a map of the plurality of different events and the plurality of different venues based on their location.

5. The method of claim 1 further comprising programing the dynamic public content interface such that the plurality of registered venues and events may be displayed on a dynamic calendar.

6. The method of claim 1 further comprising providing a registration interface created by a processor and programmed to register the plurality of different venues.

7. A method, by one or more processors associated with one or more computing devices, comprising:
registering, by one or more of the processors, a venue on a registration interface;
registering, by one or more of the processors, an event, created by the venue on a venue management interface;
generating, by one or more of the processors, a dynamic social calendar in a dynamic public content interface that displays the plurality of different events registered by the plurality of different venues;
receiving, by one or more of the processors, a location and a type of event identified by a public user on a public user interface; and
displaying, by one or more of the processors, on the dynamic social calendar in the dynamic public content interface the plurality of different venues and the plurality of different events that correspond to the location and the type of event identified by the public user on the public user interface.

8. The method of claim 7 further providing one or more servers to host the venue management user interface, the data engine, the public user interface, and the dynamic public content interface;

9. The method of claim 7 further comprising managing the events registered on the venue management interface.

10. The method of claim 7 further comprising registering a public user account on the registration interface.

11. The method of claim 10 further comprising managing the public user's account in the public user interface.

12. The method of claim 7 further comprising providing notifications to the registered venues regarding any questions, comments, or RSVPs to the venue's registered event.

13. A method, by one or more processors associated with one or more computing devices, comprising:
registering, by one or more of the processors, a venue on a registration interface;
registering, by one or more of the processors, an event, created by the venue on a venue management interface;
categorizing, by one or more of the processors, a plurality of different events registered by a plurality of different venues based on a location of the plurality of different events and a type of event;
generating, by one or more of the processors, a dynamic social calendar in a dynamic public content interface that displays the plurality of different events registered by the plurality of different venues;
receiving, by one or more of the processors, a location and a type of event identified by a public user on a public user interface; and
displaying, by one or more of the processors, on the dynamic social calendar in the dynamic public content interface the plurality of different venues and the plurality of different events that correspond to the location and the type of event identified by the public user on the public user interface.

14. The method of claim 13 further comprising managing the events registered on the venue management interface.

15. The method of claim 13 further comprising allowing a public user to browse the plurality of different venues and the plurality of different events categorized and displayed on the dynamic public content interface.

16. The method of claim 13 further comprising registering a public user account on the registration interface.

17. The method of claim 16 further comprising managing the public user's account in the public user interface.

18. The method of claim 13 further comprising providing notifications to the registered venues regarding any questions, comments, or RSVPs to the venue's registered event.

19. The method of claim 13 further comprising creating a customized venue page within the venue management user interface that is linked to the dynamic public content interface.

20. The method of claim 13 further comprising creating a customized event page within the venue management user interface that is linked to the dynamic public content interface.
